(19) United States
(12) Patent Application Publication
(10) Pub. No.: US 2026/0103402 A1
(43) Pub. Date: Apr. 16, 2026

(54) METHODS AND SYSTEMS FOR DIRECT-CONTACT EVAPORATION AND CONDENSATION, AND DESALINATION METHODS AND SYSTEMS EMPLOYING THE SAME

(71) Applicant: Global Water Farms Corporation, La Quinta, CA (US)

(72) Inventors: Jonathan BECKER, La Quinta, CA (US); Brian VOCKEL, La Quinta, CA (US)

(21) Appl. No.: 19/120,714

(22) PCT Filed: Oct. 13, 2023
(86) PCT No.: PCT/US2023/076864

§ 371 Date: Apr. 11, 2025

Related U.S. Application Data
(60) Provisional application No. 63/415,966, filed on Oct. 13, 2022.

(51) Int. Cl. C02F 1/10; C02F 1/04; C02F 103/08; F28D 21/00

(52) U.S. Cl. CPC C02F 1/10; C02F 1/043; C02F 1/048; C02F 2103/08; C02F 2201/002; C02F 2209/02; C02F 2209/03; C02F 2209/10; C02F 2303/10; F28D 2021/0066

(57) ABSTRACT

Direct-contact evaporators, suitable (for example) to humidify a stream of air, and direct-contact condensers, suitable (for example) to dehumidify a stream of air, are provided. In the disclosed direct-contact evaporators, heat and mass are transferred from a hot liquid stream to a cooler gas stream, while in the disclosed direct-contact condensers, heat and mass are transferred from a hot gas stream to a cooler liquid stream. Methods for humidifying and/or dehumidifying air and evaporating and/or condensing water using such direct-contact evaporators and condensers are also provided, as are humidification/dehumidification (HDH) water desalination systems comprising such direct-contact evaporators and condensers.

### CROSS-REFERENCE TO RELATED APPLICATIONS

This application claims the benefit of priority of U.S. Provisional Patent Application 63/415,966, filed 13 Oct. 2022, the entirety of which is incorporated herein by reference.

### FIELD

This disclosure relates generally to evaporators and condensers, and particularly to direct-contact evaporators condensers and their use for humidification and/or dehumidification of a gas stream, e.g., in a water desalination process.

### BACKGROUND

A direct-contact condenser is a heat exchanger in which hot vapor and cool liquid are introduced into a vessel and allowed to mix directly, rather than being separated by a barrier such as the wall of a heat exchanger tube. As a result of this direct contact, the vapor gives up its latent heat and condenses to a liquid, while the liquid absorbs this heat and its temperature increases. The entering vapor and liquid typically contain a single condensable substance, such as water (vapor). A direct-contact evaporator is similar but operates in the reverse manner, i.e., cool vapor and hot liquid mix directly such that the liquid absorbs latent heat and evaporates to the vapor phase, while the vapor gives up this heat and its temperature decreases.

Humidification-dehumidification desalination (“HDH desalination,” or “HDD”) is a process in which water is evaporated from a stream of sea water or brackish water to generate humid air, which is subsequently cooled to condense water therefrom. Both the evaporation and the condensation can be energy-intensive, and it is thus desirable to maximize the energy efficiency of these processes.

It is thus desirable to utilize direct-contact condensers and/or evaporators in an HDH desalination process in a manner that maximizes the energy efficiency of the process.

### SUMMARY

In an aspect of the present disclosure, a water desalination system comprises a direct-contact humidifier, configured to receive a first stream of a carrier gas and a first stream of a brine and place the first stream of the carrier gas and the first stream of the brine in direct contact to cause transfer of heat and water from the first stream of the brine to the first stream of the carrier gas to form a second stream of the carrier gas and a second stream of the brine, wherein the first stream of the brine has a brine set point temperature; a direct-contact condenser, configured to receive the second stream of the carrier gas and a first stream of a condensate and place the second stream of the carrier gas and the first stream of the condensate in direct contact to cause transfer of heat and water from the second stream of the carrier gas to the first stream of the condensate to form a third stream of the carrier gas and a second stream of the condensate, wherein the first stream of the condensate has a condensate set point temperature; a blowdown conduit, configured to discharge a portion of the second stream of the brine from the water desalination system to form a third stream of the brine; a makeup brine conduit, configured to combine the third stream of the brine with a stream of makeup brine to form a fourth stream of the brine; a gas discharge conduit, configured to discharge a portion of the second stream of the carrier gas to form a third stream of the carrier gas; a makeup carrier gas conduit, configured to combine the third stream of the carrier gas with a makeup carrier gas stream to form the first stream of the carrier gas for recycle to the direct-contact humidifier; a product water conduit, configured to discharge a portion of the second stream of the condensate from the water desalination system as a product water stream and thereby form a third stream of the condensate; a recuperator, configured to receive the fourth stream of the brine and the third stream of the condensate and exchange heat from the third stream of the condensate to the fourth stream of the brine to form a fifth stream of the brine and a fourth stream of the condensate; a heat source, configured to heat the fifth stream of the brine to the brine set point temperature and thereby form the first stream of the brine for recycle to the direct-contact humidifier; and a heat sink, configured to cool the fourth stream of the condensate to the condensate set point temperature and thereby form the first stream of the condensate for recycle to the direct-contact condenser.

In embodiments, the heat source may be a heat engine comprising an evaporator, configured to receive heat from a thermal source and supply at least a portion of the received heat to a working fluid of the heat engine; an expander and an electric generator, collectively configured to extract mechanical work from the working fluid to produce electricity; and a condenser, configured to receive the working fluid and the fifth stream of the brine and exchange heat from the working fluid to the fifth stream of the brine.

In embodiments, the heat sink may comprise an organic Rankine cycle-integrated dry air cooler.

In embodiments, the heat source and the heat sink may be collectively configured as a heat pump comprising: a first heat exchanger, configured to receive the fourth stream of the condensate and a first stream of a refrigerant and exchange heat from the fourth stream of the condensate to the first stream of the refrigerant to form a second stream of the refrigerant; a compressor, configured to compress the second stream of the refrigerant to form a third stream of the refrigerant; and a second heat exchanger, configured to receive the fifth stream of the brine and the third stream of the refrigerant and exchange heat from the third stream of the refrigerant to the fifth stream of the brine to form the first stream of the refrigerant for recycle to the first heat exchanger.

In embodiments, at least one of the direct-contact humidifier and the direct-contact condenser may comprise a stacked cassette tower.

In embodiments, a total dissolved solids content of the product water stream may be no more than about 20 ppm.

In embodiments, the carrier gas may comprise air.

In embodiments, the water desalination system may further comprise a blower configured to induce a pressure gradient of the carrier gas in the direct-contact humidifier.

In embodiments, the portion of the second stream of the carrier gas discharged by the gas discharge conduit may be about 5.0% to about 15.0%, by mass or volume, of the second stream of the carrier gas.

In embodiments, the water desalination system may further comprise one or more pumps configured to pressurize at least one of the fourth stream of the brine and the third stream of the condensate before the fourth stream of the brine and the third stream of the condensate enter the recuperator.

In embodiments, the heat source may derive thermal energy from at least one of a concentrated solar power source, a geothermal source, industrial waste heat, and a petroleum-based thermal heater.

In embodiments, the heat sink may comprise at least one of a cooling tower, an air-cooled chiller, an adiabatic cooler, and a dry air cooler.

In embodiments, the brine may comprise a dissolved salt selected from the group consisting of sodium chloride (NaCl), sodium bromide (NaBr), potassium chloride (KCl), potassium bromide (KBr), ammonium chloride (NH₄Cl), calcium chloride (CaCl₂), magnesium chloride (MgCl₂), sodium carbonate (Na₂CO₃), sodium bicarbonate (NaHCO₃), potassium bicarbonate (KHCO₃), sodium sulfate (Na₂SO₄), potassium sulfate (K₂SO₄), calcium sulfate (CaSO₄), magnesium sulfate (MgSO₄), strontium sulfate (SrSO₄), barium sulfate (BaSO₄), barium-strontium sulfate (BaSr(SO₄)₂), calcium nitrate (Ca(NO₃)₂), iron (III) hydroxide (Fe(OH)₃), iron (III) carbonate (Fe₂(CO₃)₃), aluminum hydroxide (Al(OH)₃), aluminum carbonate (Al₂(CO₃)₃), ammonium carbonate, ammonium bicarbonate, ammonium sulfate, boron salts, polyacrylic acid sodium salts, silicates, and combinations and mixtures thereof.

In embodiments, the brine may comprise at least one of seawater, brackish water, water produced from an oil and/or gas extraction process, flowback water, and wastewater.

In embodiments, a difference between a boiling point of the first stream of the brine and the brine set point temperature may be no more than about 15° C., no more than about 14° C., no more than about 13° C., no more than about 12° C., no more than about 11° C., no more than about 10° C., no more than about 9° C., no more than about 8° C., no more than about 7° C., no more than about 6° C., no more than about 5° C., no more than about 4° C., no more than about 3° C., no more than about 2° C., no more than about 1° C., no more than about 0.9° C., no more than about 0.8° C., no more than about 0.7° C., no more than about 0.6°C., no more than about 0.5° C., no more than about 0.4° C., no more than about 0.3° C., no more than about 0.2° C., or no more than about 0.1° C.

In embodiments, a concentration of dissolved salts in at least one stream of the brine may be at least about 1,000 mg/L, at least about 5,000 mg/L, at least about 10,000 mg/L, at least about 50,000 mg/L, at least about 100,000 mg/L, at least about 150,000 mg/L, at least about 200,000 mg/L, at least about 250,000 mg/L, at least about 300,000 mg/L, at least about 350,000 mg/L, or at least about 375,000 mg/L.

In embodiments, a concentration of dissolved salts in at least one stream of the brine may be no more than about 375,000 mg/L, no more than about 350,000 mg/L, no more than about 300,000 mg/L, no more than about 250,000 mg/L, no more than about 200,000 mg/L, no more than about 150,000 mg/L, no more than about 100,000 mg/L, no more than about 50,000 mg/L, no more than about 10,000 mg/L, or no more than about 1,000 mg/L.

In embodiments, at least one stream of the brine may comprise dissolved salts in an amount of at least about 1 wt %, at least about 5 wt %, at least about 10 wt %, at least about 15 wt %, at least about 20 wt %, at least about 25 wt %, at least about 26 wt %, at least about 27 wt %, at least about 28 wt %, at least about 29 wt %, or at least about 30 wt %.

In embodiments, at least one stream of the brine may comprise dissolved salts in an amount of no more than about 30 wt %, no more than about 29 wt %, no more than about 28 wt %, no more than about 27 wt %, no more than about 26 wt %, no more than about 25 wt %, no more than about 20 wt %, no more than about 15 wt %, no more than about 10 wt %, no more than about 5 wt %, or no more than about 1 wt %.

In embodiments, water may make up at least about 95 wt %, at least about 99 wt %, at least about 99.9 wt %, at least about 99.99 wt %, or at least about 99.998 wt % of at least one stream of the condensate.

In embodiments, a total dissolved solids concentration in at least one stream of the condensate may be no more than about 500 mg/L, no more than about 200 mg/L, no more than about 100 mg/L, no more than about 50 mg/L, no more than about 20 mg/L, no more than about 10 mg/L, no more than about 5 mg/L, no more than about 2 mg/L, no more than about 1 mg/L, no more than about 0.5 mg/L, no more than about 0.2 mg/L, no more than about 0.1 mg/L, no more than about 0.05 mg/L, no more than about 0.02 mg/L, or no more than about 0.01 mg/L.

In embodiments, at least one stream of the condensate may comprise dissolved salts in an amount of no more than about 2 wt % (20,000 ppm), no more than about 1 wt % (10,000 ppm), no more than about 0.5 wt % (5,000 ppm), no more than about 0.2 wt % (2,000 ppm), no more than about 0.1 wt % (1,000 ppm), no more than about 0.05 wt % (500 ppm), no more than about 0.02 wt % (200 ppm), no more than about 0.01 wt % (100 ppm), no more than about 0.005 wt % (50 ppm), or no more than about 0.002 wt % (20 ppm).

In embodiments, at least one of a temperature rise of the fourth stream of the brine in the recuperator, a temperature rise of the fifth stream of the brine in the heat source, a temperature drop of the third stream of the condensate in the recuperator, and a temperature drop of the fourth stream of the condensate in the heat sink may be at least about 5° C., at least about 10° C., at least about 15° C., at least about 20° C., at least about 25° C., at least about 30° C., at least about 35° C., at least about 40° C., at least about 45° C., or at least about 50° C.

In embodiments, the carrier gas may comprise a non-condensable gas selected from the group consisting of air, nitrogen gas (N₂), oxygen gas (O₂), helium (He), argon (Ar), carbon monoxide (CO), carbon dioxide (CO₂), sulfur oxides (SOₓ), nitrogen oxides (NOₓ), and combinations and mixtures thereof.

In embodiments, a pressure drop of the carrier gas in the direct-contact humidifier or the direct-contact condenser may be no more than about 100 kPa, no more than about 75 kPa, no more than about 50 kPa, no more than about 20 kPa, no more than about 10 kPa, no more than about 5 kPa, no more than about 2 kPa, or no more than about 1 kPa.

In another aspect of the present disclosure, a method for producing fresh water comprises (a) contacting a first stream of a carrier gas and a first stream of a brine to cause transfer of heat and water from the first stream of the brine to the first stream of the carrier gas to form a second stream of the carrier gas and a second stream of the brine, wherein the first stream of the brine has a brine set point temperature; (b) contacting the second stream of the carrier gas and a first stream of a condensate to cause transfer of heat and water from the second stream of the carrier gas to the first stream of the condensate to form a third stream of the carrier gas and a second stream of the condensate, wherein the first stream of the condensate has a condensate set point temperature; (c) discharging a portion of the second stream of the brine to form a third stream of the brine; (d) combining the third stream of the brine with a stream of makeup brine to form a fourth stream of the brine; (e) discharging a portion of the second stream of the carrier gas to form a third stream of the carrier gas; (f) combining the third stream of the carrier gas with a makeup carrier gas stream to form the first stream of the carrier gas for recycle to step (a); (g) discharging a portion of the second stream of the condensate as a product water stream to thereby form a third stream of the condensate; (h) exchanging heat from the third stream of the condensate to the fourth stream of the brine to form a fifth stream of the brine and a fourth stream of the condensate; (i) heating the fifth stream of the brine to the brine set point temperature to thereby form the first stream of the brine for recycle to step (a); and (j) cooling the fourth stream of the condensate to the condensate set point temperature to thereby form the first stream of the condensate for recycle to step (b).

In embodiments, step (i) may comprise receiving heat from a thermal source and supplying at least a portion of the received heat to a working fluid of a heat engine; extracting mechanical work from the working fluid to produce electricity; and exchanging heat from the working fluid to the fifth stream of the brine.

In embodiments, step (j) may comprise exchanging heat from the fourth stream of the condensate to a first stream of a refrigerant to form a second stream of the refrigerant; the method may further comprise compressing the second stream of the refrigerant to form a third stream of the refrigerant; and step (i) may comprise exchanging heat from the third stream of the refrigerant to the fifth stream of the brine to form the first stream of the refrigerant for recycle to step (j).

In embodiments, a total dissolved solids content of the product water stream may be no more than about 20 ppm.

In embodiments, the carrier gas may comprise air.

In embodiments, the portion of the second stream of the carrier gas discharged in step (e) may be about 5.0% to about 15.0%, by mass or volume, of the second stream of the carrier gas.

In embodiments, the brine may comprise a dissolved salt selected from the group consisting of sodium chloride (NaCl), sodium bromide (NaBr), potassium chloride (KCI), potassium bromide (KBr), ammonium chloride (NH₄Cl), calcium chloride (CaCl₂), magnesium chloride (MgCl₂), sodium carbonate (Na₂CO₃), sodium bicarbonate (NaHCO₃), potassium bicarbonate (KHCO₃), sodium sulfate (Na₂SO₄), potassium sulfate (K₂SO₄), calcium sulfate (CaSO₄), magnesium sulfate (MgSO₄), strontium sulfate (SrSO₄), barium sulfate (BaSO₄), barium-strontium sulfate (BaSr(SO₄)₂), calcium nitrate (Ca(NO₃)₂), iron (III) hydroxide (Fe(OH)₃), iron (III) carbonate (Fe₂(CO₃)₃), aluminum hydroxide (Al(OH)₃), aluminum carbonate (Al₂(CO₃)₃), ammonium carbonate, ammonium bicarbonate, ammonium sulfate, boron salts, polyacrylic acid sodium salts, silicates, and combinations and mixtures thereof.

In embodiments, the brine may comprise at least one of seawater, brackish water, water produced from an oil and/or gas extraction process, flowback water, and wastewater. In embodiments, a difference between a boiling point of the first stream of the brine and the brine set point temperature may be no more than about 15° C., no more than about 14° C., no more than about 13° C., no more than about 12° C., no more than about 11° C., no more than about 10° C., no more than about 9° C., no more than about 8° C., no more than about 7° C., no more than about 6° C., no more than about 5° C., no more than about 4° C., no more than about 3° C., no more than about 2° C., no more than about 1° C., no more than about 0.9° C., no more than about 0.8° C., no more than about 0.7° C., no more than about 0.6° C., no more than about 0.5° C., no more than about 0.4° C., no more than about 0.3° C., no more than about 0.2° C., or no more than about 0.1 ° C.

In embodiments, a concentration of dissolved salts in at least one stream of the brine may be at least about 1,000 mg/L, at least about 5,000 mg/L, at least about 10,000 mg/L, at least about 50,000 mg/L, at least about 100,000 mg/L, at least about 150,000 mg/L, at least about 200,000 mg/L, at least about 250,000 mg/L, at least about 300,000 mg/L, at least about 350,000 mg/L, or at least about 375,000 mg/L.

In embodiments, a concentration of dissolved salts in at least one stream of the brine may be no more than about 375,000 mg/L, no more than about 350,000 mg/L, no more than about 300,000 mg/L, no more than about 250,000 mg/L, no more than about 200,000 mg/L, no more than about 150,000 mg/L, no more than about 100,000 mg/L, no more than about 50,000 mg/L, no more than about 10,000 mg/L, or no more than about 1,000 mg/L.

In embodiments, at least one stream of the brine may comprise dissolved salts in an amount of at least about 1 wt %, at least about 5 wt %, at least about 10 wt %, at least about 15 wt %, at least about 20 wt %, at least about 25 wt %, at least about 26 wt %, at least about 27 wt %, at least about 28 wt %, at least about 29 wt %, or at least about 30 wt %.

In embodiments, at least one stream of the brine may comprise dissolved salts in an amount of no more than about 30 wt %, no more than about 29 wt %, no more than about 28 wt %, no more than about 27 wt %, no more than about 26 wt %, no more than about 25 wt %, no more than about 20 wt %, no more than about 15 wt %, no more than about 10 wt %, no more than about 5 wt %, or no more than about 1 wt %.

In embodiments, water may make up at least about 95 wt %, at least about 99 wt %, at least about 99.9 wt %, at least about 99.99 wt %, or at least about 99.998 wt % of at least one stream of the condensate.

In embodiments, a total dissolved solids concentration in at least one stream of the condensate may be no more than about 500 mg/L, no more than about 200 mg/L, no more than about 100 mg/L, no more than about 50 mg/L, no more than about 20 mg/L, no more than about 10 mg/L, no more than about 5 mg/L, no more than about 2 mg/L, no more than about 1 mg/L, no more than about 0.5 mg/L, no more than about 0.2 mg/L, no more than about 0.1 mg/L, no more than about 0.05 mg/L, no more than about 0.02 mg/L, or no more than about 0.01 mg/L.

In embodiments, at least one stream of the condensate may comprise dissolved salts in an amount of no more than about 2 wt % (20,000 ppm), no more than about 1 wt % (10,000 ppm), no more than about 0.5 wt % (5,000 ppm), no more than about 0.2 wt % (2,000 ppm), no more than about 0.1 wt % (1,000 ppm), no more than about 0.05 wt % (500 ppm), no more than about 0.02 wt % (200 ppm), no more than about 0.01 wt % (100 ppm), no more than about 0.005 wt % (50 ppm), or no more than about 0.002 wt % (20 ppm).

In embodiments, at least one of a temperature rise of the fourth stream of the brine in step (h), a temperature rise of the fifth stream of the brine in step (i), a temperature drop of the third stream of the condensate in step (h), and a temperature drop of the fourth stream of the condensate in step (j) may be at least about 5° C., at least about 10° C., at least about 15° C., at least about 20° C., at least about 25° C., at least about 30° C., at least about 35° C., at least about 40° C., at least about 45° C., or at least about 50° C.

In embodiments, the carrier gas may comprise a non-condensable gas selected from the group consisting of air, nitrogen gas (N₂), oxygen gas (O₂), helium (He), argon (Ar), carbon monoxide (CO), carbon dioxide (CO₂), sulfur oxides (SOₓ), nitrogen oxides (NOₓ), and combinations and mixtures thereof.

In embodiments, a pressure drop of the carrier gas in step (a) or step (b) may be no more than about 100 kPa, no more than about 75 kPa, no more than about 50 kPa, no more than about 20 kPa, no more than about 10 kPa, no more than about 5 kPa, no more than about 2 kPa, or no more than about 1 kPa.

In another aspect of the present disclosure, a stacked cassette tower (SCT) useful as a direct-contact condenser and/or a direct-contact evaporator comprises N interconnected cassettes arranged in a vertical stack, where N is an integer greater than or equal to two, each cassette having a circular or nearly circular cross-section and comprising a lower chamber, comprising a substantially fluid-impermeable floor; an upper chamber; a vertical wall, disposed about a circumference of the cassette and defining an outermost extent of the cassette, comprising a plurality of orifices in a portion of the vertical wall associated with the upper chamber; a barrier layer, lying between the lower chamber and the upper chamber and comprising a perforation array, the perforation array comprising a plurality of perforations extending through an entirety of a thickness of the barrier layer and permitting flow of a carrier gas from the lower chamber into the upper chamber; and a downpipe, in fluid communication with the upper chamber and extending downwardly from the upper chamber through an entirety of a height of the lower chamber; an outer cylinder, having a circular or nearly circular cross-section and comprising a base; at least one carrier gas inlet, in fluid communication with both a source of the carrier gas and the lower chamber of at least one cassette and configured to convey the carrier gas from the source of the carrier gas into the lower chamber of the at least one cassette; and at least one liquid inlet, in fluid communication with both a source of a liquid and the upper chamber of at least one cassette and configured to convey the liquid from the source of the liquid into the upper chamber of the at least one cassette; and a lid, comprising a carrier gas outlet, wherein an outer diameter of each of the cassettes is less than an inner diameter of the outer cylinder such that an annular space exists within the outer cylinder between the stack of cassettes and the outer cylinder, wherein the plurality of orifices in the vertical wall of each cassette is in fluid communication with the annular space and permits flow of the carrier gas from the upper chamber of each cassette into the annular space, wherein a lower end of the downpipe of each cassette other than the bottom-most cassette in the stack penetrates through the floor of the lower chamber and thereafter terminates in, and is in fluid communication with, an upper end of the downpipe of the immediately below cassette, and wherein a lower end of the downpipe of the bottom-most cassette in the stack is in fluid communication with, and configured to dispense a stream of the liquid into, a reservoir contained within the base of the outer cylinder.

In embodiments, the SCT may comprise from two to ten cassettes.

In embodiments, at least one perforation may be circular or nearly circular.

In embodiments, at least one perforation may have a diameter of about 40 μm to about 4,000 μm.

In embodiments, the perforations may have an average diameter of about 400 μm.

In embodiments, the perforation array of at least one cassette may comprise about 2,000 to about 200,000 perforations. The perforation array of at least one cassette may, but need not, comprise about 20,000 perforations.

In embodiments, at least one of the following may be true: (i) the at least one carrier gas inlet comprises N carrier gas inlets, wherein each of the N carrier gas inlets is in fluid communication with the dry chamber of a separate cassette; and (ii) the at least one liquid inlet comprises N liquid inlets, wherein each of the N liquid inlets is in fluid communication with the wet chamber of a separate cassette.

In embodiments, at least one liquid inlet may be configured to introduce liquid into the wet chamber of the corresponding cassette substantially tangentially to the vertical wall of the cassette.

In embodiments, the SCT may further comprise a mist eliminator, configured to prevent carryover of liquid droplets in the carrier gas exiting the SCT via the carrier gas outlet.

In embodiments, the floor of the dry chamber of at least one cassette may be a ceiling of the wet chamber of the immediately below cassette in the stack.

In embodiments, at least two cassettes may be mechanically interlocked and/or interconnected to one another.

In embodiments, at least one cassette may be mechanically interlocked and/or interconnected to the lid. All of the cassettes may, but need not, be mechanically interlocked and/or interconnected to the lid and the lid may, but need not, be openable or removable.

While specific embodiments and applications have been illustrated and described, the present disclosure is not limited to the precise configuration and components described herein. Various modifications, changes, and variations which will be apparent to those skilled in the art may be made in the arrangement, operation, and details of the methods and systems disclosed herein without departing from the spirit and scope of the overall disclosure.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

As used herein, unless otherwise specified, the term “condensable fluid” refers to a fluid that can be converted from the liquid phase to the vapor phase under at least one set of operating conditions within a direct-contact evaporator, or that can be converted from the vapor phase to the liquid phase under at least one set of operating conditions within a direct-contact condenser. By extension, the terms “condensable liquid” and “condensable vapor” refer to a condensable fluid in the liquid state and a condensable fluid in the vapor state, respectively.

As used herein, unless otherwise specified, the term “condenser” refers to any apparatus in which a fluid is condensed from the vapor phase to the liquid phase. A condenser in which water is condensed from a stream of a carrier gas may be referred to herein as a “dehumidifier.”

As used herein, unless otherwise specified, the term “evaporator” refers to any apparatus in which a fluid is evaporated from the liquid phase to the vapor phase. An evaporator in which water is evaporated into a stream of a carrier gas may be referred to herein as a “humidifier.”

The embodiments and configurations described herein are neither complete nor exhaustive. As will be appreciated, other embodiments are possible utilizing, alone or in combination, one or more of the features set forth above or described in detail below.

### BRIEF DESCRIPTION OF THE DRAWINGS

FIG. 1 is a perspective view of a packed-bed direct-contact condenser that has been repurposed for use as a humidifier column, according to embodiments of the present disclosure.

FIG. 2 is a cutaway front view of a perforated-tray direct-contact condenser that has been repurposed for use as a humidifier column, according to embodiments of the present disclosure.

FIG. 3 is an illustration of a humidification/dehumidification (HDH) water desalination system comprising a direct-contact humidifier, a direct-contact condenser, a recuperator, a heat source, and a heat sink, according to embodiments of the present disclosure.

FIG. 4 is an illustration of an embodiment of the HDH water desalination system illustrated in FIG. 3 in which the heat source is a Rankine cycle powered by a mid-grade heat source and the heat sink is an organic Rankine cycle-integrated dry air cooler, according to embodiments of the present disclosure.

FIG. 5 is an illustration of an embodiment of the HDH water desalination system illustrated in FIG. 3 in which a heat pump transfers heat from an outlet stream of the direct-contact condenser to an inlet stream of the direct-contact humidifier, according to embodiments of the present disclosure.

FIGS. 6A and 6B are a cutaway perspective view and a side view, respectively, of a cassette of a stacked tray cassette (SCT) tower, according to embodiments of the present disclosure.

FIG. 7 is an illustration of an SCT comprising a plurality of stacked cassettes, according to embodiments of the present disclosure.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

For purposes of further disclosure and to comply with applicable written description requirements, the following references generally relate to apparatuses, methods, and systems for purifying water and related apparatuses, methods, and systems, and are hereby incorporated by reference in their entireties:

U.S. Pat. No. 10,144,655, entitled “Systems and methods for distillation of water from seawater, brackish water, waste waters, and effluent waters,” issued 4 Dec. 2018 to Becker et al.

U.S. Pat. No. 10,414,670, “Systems and methods for distillation of water from seawater, brackish water, waste waters, and effluent waters,” issued 17 Sep. 2019 to Becker et al.

### General Direct-Contact Evaporation Design and Concepts

The present disclosure relates generally to direct-contact evaporators that are useful to humidify a gas stream and/or direct-contact condensers that are useful to dehumidify a gas stream. Particularly, direct-contact evaporators as disclosed herein may be useful to humidify a stream of air, as may be desirable in, by way of non-limiting example, a humidification-dehumidification (HDH) water desalination process. In many cases, the direct-contact evaporators disclosed herein may be direct-contact condensers that have been repurposed to essentially reverse the process of direct-contact condensation, i.e., to transfer moisture from a hot liquid stream to a cooler vapor stream, rather than from a hot vapor stream to a cooler liquid stream. Methods of using such direct-contact evaporators, e.g., in an HDH water desalination process, are also within the scope of the present disclosure.

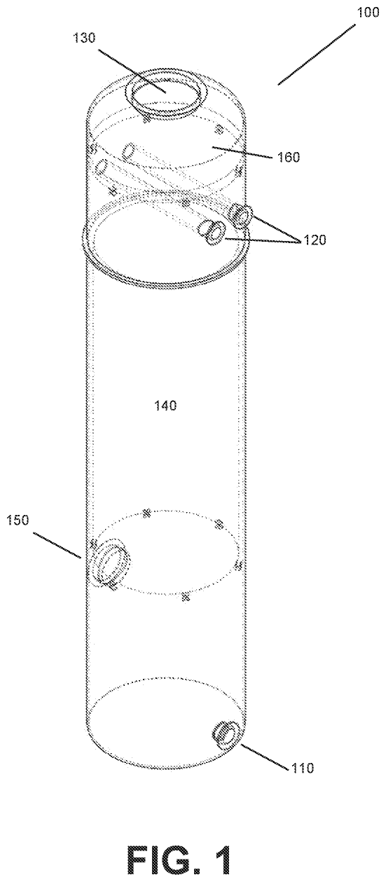

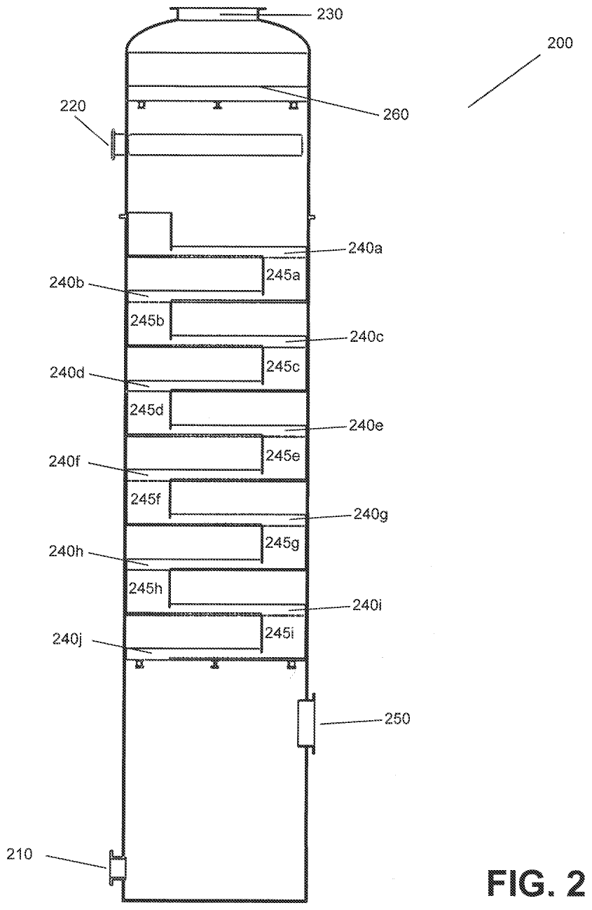

Referring now to FIGS. 1 and 2, in embodiments of the present disclosure, the direct-contact evaporator 100,200 is a column that receives a stream of air that is relatively warm (most typically, having a temperature of about 100 to about 150 ° F.) and relatively humid (ideally, having a relative humidity of 100% or nearly 100%, i.e., being fully or nearly fully saturated with water). In a typical configuration, the air stream enters the column 100,200 via an air inlet 110,210 near the base of the column such that it naturally rises through the interior of the column toward the top of the column. As the air stream ascends through the column, it encounters a descending flow of liquid that has a higher temperature than the air stream and has been introduced via a liquid inlet 120,220 at a higher point in the column (most typically, near the top of the column); in many embodiments, this liquid stream is a hot aqueous solution. The temperature of the liquid stream may in some embodiments be preselected to produce an outlet gas stream at a desired temperature, which exits the column via an air discharge vent 130,230, and in such embodiments the direct-contact evaporator 100,200 (or a system of which it is a part) may be provided with a heater to heat the incoming liquid to the preselected temperature. While in many cases the liquid stream is a solution of sodium chloride (NaCl) such as seawater, brackish water, brine, etc., it is to be expressly understood that the solute may vary depending on the application.

Although the air stream is fully or nearly fully saturated with water when it enters the column, contact with the hotter liquid stream increases the temperature and, consequently, the water saturation pressure of the air stream. To take advantage of this increase in the air stream's capacity to carry water vapor, the flow rate of the liquid stream into the column should preferably be selected to meet both the thermal load attributed to the heating of the inlet air to the desired temperature (sensible load) and the evaporation of water out of the liquid solution and into the air stream at a desired rate (latent load) such that thermal equilibrium between the inlet liquid stream and the exiting air is achieved at the point 130,230 at which the air stream is discharged from the column.

To increase the contact area between the air stream and the liquid stream and thus enhance the rate of heat and mass transfer between the two streams, the interior of the column may contain either or both of a packed bed 140 occupying a central portion of the column (as illustrated in FIG. 1) or a series of trays 240a,b, . . . (as illustrated in FIG. 2). The packed bed 140 of the column 100 illustrated in FIG. 1 can have either a random packing or an organized packing, depending on the required surface area, pressure drop considerations, cost considerations, etc. The series of trays 240a,b, . . . illustrated in FIG. 2 consists of one or more trays (e.g., bubble cap trays, sieve trays, valve trays, etc.), each tray including a number of orifices or perforations; the orifices/perforations allow the air stream to penetrate the liquid that has collected on each tray, such that the action of the air passing directly through the liquid induces mass and energy transfer between the two fluid streams. Any one or more trays 240a,b, . . . may also include a downcomer 245a,b, . . . that isolates the liquid stream and facilitates the transfer of liquid from the tray above and/or, in the case of the lowermost tray, discharges the liquid from the last tray into a liquid reservoir (not shown) at the bottom of the column. In either case, liquid collected at the bottom of the column may then be discharged via a liquid discharge port 150,250.

Some embodiments of the direct-contact evaporators of the present disclosure may further comprise a drift collector 160,260 within an outlet of the gas stream, as illustrated in FIGS. 1 and 2. The drift collector is configured to collect liquid droplets that may be entrained within the air stream. Collection of these droplets may improve the purity (i.e., lower the salt content) of the water vapor that is contained within the air stream.

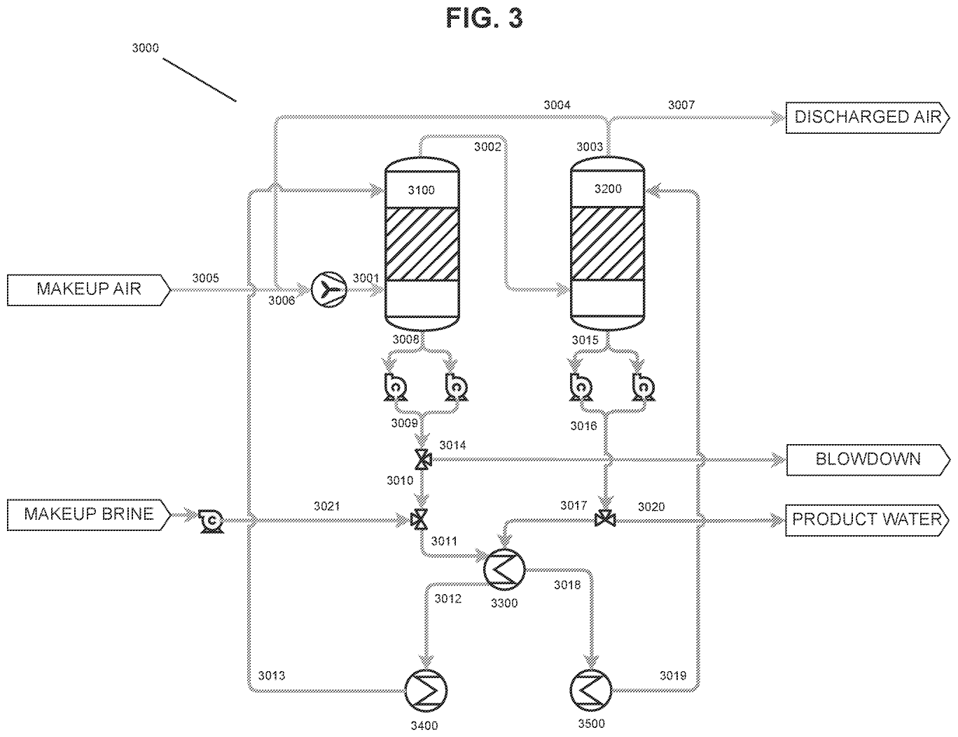

As further described elsewhere throughout this disclosure, a packed-bed column as illustrated in FIG. 1 or a tray column as illustrated in FIG. 2 can be used as a direct-contact condenser and/or a direct-contact evaporator, and particularly can be used as a direct-contact humidifier 3100 and/or a direct-contact condenser 3200 in a water desalination system 3000 as illustrated in FIG. 3 and further described below.

### Stacked Cassette Tower

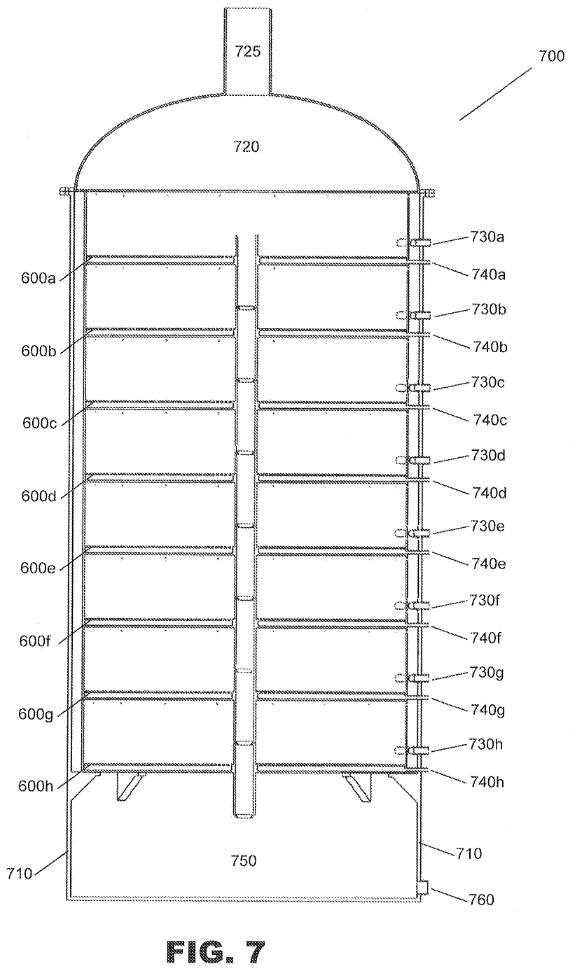

Aspects of the present disclosure include a direct-contact column, referred to herein as a stacked cassette tower (SCT), useful for evaporation and/or humidification of a carrier gas stream (i.e., as a direct-contact evaporator), and/or, in some embodiments, condensation and/or dehumidification of a carrier gas stream (i.e., as a direct-contact condenser). Referring now to FIG. 7, the SCT 700 generally comprises an outer cylinder 710, a head or lid 720, and a plurality of interconnected trays 600a,b, . . . (e.g., at least two trays, at least three trays, at least four trays, at least five trays, at least six trays, at least seven trays, at least eight trays, at least nine trays, or at least ten trays, or, additionally or alternatively, any number of trays in any range having a lower bound of any whole number from two to ten and an upper bound of any other whole number from two to ten). Both the cylinder 710 and each of the plurality of trays 600a,b, . . . have a circular or nearly circular cross-section, and a diameter of the trays 600 is smaller than an inner diameter of the cylinder 710, such that an annular space exists between the outermost extent of the trays 600 and the inner wall of the outer cylinder 710.

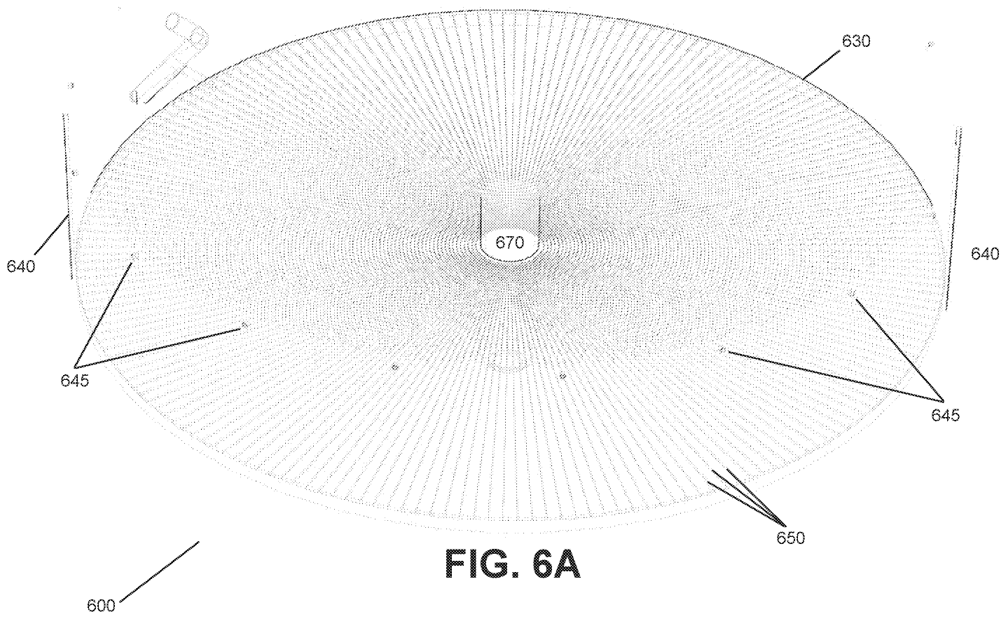

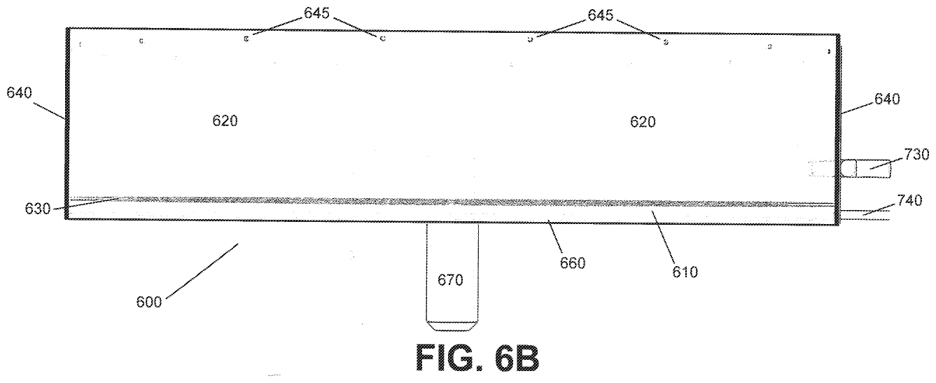

Referring now to FIGS. 6A and 6B, each tray 600, also referred to herein as a cassette, of the SCT 700 is a thin-walled device of circular or nearly circular cross-section comprising two chambers, a lower “dry” chamber 610 and an upper “wet” chamber 620. The two chambers are separated by a barrier layer 630, fabricated into an inner profile of the cassette wall 640, that serves as both a “floor” of the upper wet chamber 620 and a “ceiling” of the lower dry chamber 610. Disposed across a significant portion (and in many embodiments, all or substantially all) of the surface area of the barrier layer 630 is a perforation array 650 comprising a plurality of perforations; each perforation extends through the entire thickness of the barrier layer 630 and thus serves as a channel to facilitate the transfer of carrier gas from the dry chamber 610 upwardly into the wet chamber 620. The perforations may have any shape but will most typically be circular or nearly circular, and may likewise have any diameter sufficient to allow for passage of the carrier gas stream from the dry chamber 610 to the wet chamber 620; by way of non-limiting example, the diameter of the perforations may be in any range having a lower bound of any whole number of micrometers from 40 μm (0.04 mm) to 4,000 μm (4 mm) and an upper bound of any other whole number of micrometers from 40 μm (0.04 mm) to 4,000 μm (4 mm), and in many typical embodiments may be about 400 μm (0.4 mm). The number of perforations in the perforation array 650 of each barrier layer may likewise vary, so long as it is sufficient to allow for passage of the carrier gas stream from the dry chamber 610 to the wet chamber 620; by way of non-limiting example, the number of perforations per barrier layer 630 may be in any range having a lower bound of any whole number from 2,000 to 200,000 and an upper bound of any other whole number from 2,000 to 200,000, and in many typical embodiments may be about 20,000.

Referring again to FIG. 7, the interior of the SCT 700 comprises multiple cassettes 600a,b, . . . arranged in vertical sequence, i.e., a “stack.” In embodiments, the outer cylinder 710 of the SCT 700 may comprise multiple liquid inlets 730a,b, . . . and multiple gas inlets 740a,b, . . . and particularly may be configured with a dedicated liquid inlet 730 and a dedicated gas inlet 740 for each cassette 600, such that each cassette 600 can operate independently of and/or in parallel with the other cassettes.

In operation, the carrier gas stream and a stream of liquid (typically an aqueous liquid, and in many embodiments brackish water, brine, saltwater, etc.) flow generally counter-currently to each other through the interior of the SCT 700 and exchange liquid content (either from the liquid stream to the carrier gas stream in the case of humidification/evaporation, or from the carrier gas stream to the liquid stream in the case of dehumidification/condensation) via direct contact as a result of this counter-current flow. Specifically, carrier gas is introduced into the interior of the SCT 700 via a conduit/gas inlet 740 that fluidly connects an external source of the carrier gas with the dry chamber 610 of any given cassette; the carrier gas then penetrates the dry chamber 610 through the perforations of the barrier layer 630 upwardly into the wet chamber 620, and then exits the wet chamber 620 of the cassette into the annular space through one or more orifices 645 in an upper portion of the outer wall 640 of the wet chamber 620. The carrier gas exiting the wet chamber 620 into the annular space 730 thus rises to the top of the column, such that the carrier gas exiting each of the several cassettes 600a,b, . . . accumulates in the lid 720 of the SCT 700 and evacuates the SCT 700 through a common carrier gas outlet 725 in the lid 720. In some embodiments, mist eliminators may be located at any one or more wet chamber orifices 645, at the carrier gas outlet 725, or at both locations, to prevent carryover of liquid droplets in the combined carrier gas stream that exits the SCT 700. Optionally, the base 660 of any cassette 600 other than the bottom-most cassette in the stack (e.g., the “floor” of the dry chamber 610 of the cassette 600), which is substantially impermeable by the carrier gas and the liquid, may also serve as a “ceiling” of the wet chamber 620 of the immediately below cassette in the stack, to ensure that the carrier gas introduced into the immediately below cassette exits the cassette exclusively via the orifice(s) 645 in the wall 640 of the wet chamber 620 into the annular space.

Meanwhile, liquid is introduced into the interior of the SCT via a conduit 730 that fluidly connects an external source of the liquid with the wet chamber 620 of any given cassette 600. The liquid then discharges from the wet chamber 620 through a downpipe 670 that extends from the wet chamber 620 through the dry chamber 610 of the same cassette 600 and (in the case of each cassette 600 except the bottom-most cassette) into the wet chamber 620 of the immediately below cassette. In typical embodiments, this downpipe 670 is located at or near a center of the circular or near-circular cross-section of the cassette 600 and has a generally cylindrical shape, and the bottom end of the downpipe 670 (in the case of each cassette 600 except the bottom-most cassette) mates with the top end of the downpipe of the immediately below cassette such that the downpipes 670 of all cassettes 600 are collectively “end-to-end” and thus provide a continual flow path of the falling liquid throughout the SCT 700; one or more ends of one or more downpipes 670 may be tapered and/or chamfered to provide for this mating with a corresponding end of a downpipe of an adjacent cassette. In this way, the liquid discharge from each cassette 600 combines with the liquid discharge from the other cassettes as it flows by force of gravity downwardly through the SCT 700. The downpipe of the bottom-most cassette in the stack discharges the accumulated liquid discharges of all cassettes 600a,b, . . . into a reservoir 750 at the base of the SCT column, and this accumulated liquid may then be discharged from the SCT via a common liquid outlet 760 fluidly connected to the reservoir.

Heat and mass transfer between the carrier gas and the liquid occurs with the confines of each of the plurality of cassettes 600a,b, . . . In humidification applications, where the liquid influent to each cassette 600 is a relatively hot liquid (in many embodiments, a hot brine), a portion of the water content of the liquid stream is transferred to the carrier gas as water vapor. To induce high levels of evaporation in these applications, the liquid entering the wet chamber 620 may be introduced at an angle that is nearly tangential to the circular or nearly circular wall 640 of the cassette 600 to induce a whirlpool effect within the wet chamber 620; this whirlpool effect enhances heat and mass transfer between the carrier gas and the liquid by increasing the residence time of the liquid in the wet chamber 620, increasing the turbidity of the liquid, and/or increasing the angular velocity of the liquid within the wet chamber 620. This whirlpool effect may be further enhanced by providing multiple liquid inlets 730 in association with each cassette 600 at different points along the circumference of the cassette wall 640 and/or by introducing the liquid into the wet chamber 620 at high velocity (e.g., providing a “jet” of liquid into the wet chamber).

A further effect of the whirlpool-or vortex-like flow path of liquid within the wet chamber 620 of each cassette 600 is a radial temperature gradient within the cassette, i.e., the hot influent liquid cools adiabatically as it flows inwardly toward the downpipe 670, and thus the liquid nearer the center of the cassette 600 will be cooler than the liquid nearer the cassette wall 640. As a result, the liquid exiting each cassette 600 will have a significantly lower temperature than the liquid entering the same cassette. The implications of these temperature gradients and differences with respect to energy balance and recovery of the SCT 700, or a larger system of which it is a part, are discussed elsewhere throughout this disclosure.

In some embodiments, and in contrast to conventional bubble tray-type separation vessels, two or more cassettes 600 may be mechanically interlocked and/or interconnected to one another (e.g., via bolts), and/or at least one cassette 600 may be mechanically interlocked and/or interconnected to the lid or head 720 of the SCT 700 (e.g., via bolts). In these embodiments, it may be possible to remove at least one cassette, and in some embodiments the entire cassette stack, from the interior of the SCT 700 by opening or removing the SCT lid 720. This feature allows easy and rapid exchange or replacement of internal components, e.g., cassettes 600 that have become corroded, fouled, or scaled, and thus improves the ease and efficiency of maintenance of the SCT 700.

Although the foregoing discussion of the SCT 700 of the present disclosure has generally described the SCT 700 with reference to humidification and/or evaporation applications, it is to be expressly understood that embodiments of the SCT 700 may also suitably be used, mutatis mutandis, in dehumidification and/or condensation applications. As further described elsewhere throughout this disclosure, an SCT 700 as illustrated in FIG. 7 can be used as a direct-contact condenser and/or a direct-contact evaporator, and particularly can be used as a direct-contact humidifier 3100 and/or a direct-contact condenser 3200 in a water desalination system 3000 as illustrated in FIG. 3 and further described below.

### Water Desalination via Direct-Contact Humidification and Dehumidification

Referring now to FIG. 3, a direct contact-evaporator and a direct-contact condenser, either or both of which may be a direct-contact device and/or SCT as described above (e.g., a direct-contact device as illustrated in FIG. 1 or FIG. 2 and/or an SCT as described in the preceding section of the disclosure and illustrated in FIG. 7), are incorporated into a water desalination system 3000. The water desalination system 3000 includes at least a direct-contact humidifier (DCH) 3100, a direct-contact condenser (DCC) 3200, a recuperator 3300, a heat source 3400, and a heat sink 3500. The water desalination system 3000 illustrated in FIG. 3 enables the extraction of relatively pure water (in many embodiments, a water stream having a total dissolved solids content of no more than about 20 ppm) from an impure water source, e.g., brine water, brackish water, etc., by exploiting the vapor-liquid equilibrium (VLE) between a brine and a carrier gas and between the carrier gas and distilled water, and can thus be referred to as a humidification-dehumidification desalination (HDD) system. Three process fluids-a carrier gas, a brine, and a condensate circulate within the water desalination system 3000 within a partially closed loop, as further described below.

A first stream 3001 of the carrier gas, which in many embodiments is atmospheric air, enters the DCH 3100 and rises through the column of the DCH 3100 due to a pressure gradient, which may in embodiments be induced by a blower upstream of the DCH 3100. The transfer of mass and energy via direct contact between the rising carrier gas and the falling brine results in the output from the DCH 3100 of a second stream 3002 of the carrier gas that has a higher temperature and a higher moisture content than the first stream 3001 of the carrier gas entering the DCH 3100. This second stream 3002 of the carrier gas is then channeled directly into the DCC 3200 via a conduit. Within the DCC 3200, an effectively reverse operation occurs: the transfer of mass and energy via direct contact between the rising carrier gas and the falling condensate results in the output from the DCC 3200 of a third stream 3003 of the carrier gas that has a lower temperature and a lower moisture content than the second stream 3002 of the carrier gas entering the DCC 3200. To prevent the buildup of non-condensable contaminant gases, a small fraction 3007 of the third stream 3003 of the carrier gas exiting the DCC 3200 is discharged from the system; most typically, the discharged fraction 3007 is about 5.0% to about 15.0%, or alternatively in any range having a lower bound of any tenth of a percentage point from 5.0% to 15.0% and an upper bound of any other tenth of a percentage point from 5.0% to 15.0%, of the third stream 3003. The remainder 3004 of the third stream 3003 of the carrier gas exiting the DCC 3200 is combined with a stream 3005 of makeup carrier gas that effectively replaces the discharged fraction 3007, and this combined stream 3006 of the carrier gas is channeled to the intake of the DCH 3100 (or the blower upstream thereof that induces the pressure gradient in the DCH 3100).

A first stream 3013 of the brine enters the DCH 3100 and falls under the force of gravity through the column of the DCH 3100. The transfer of mass and energy via direct contact between the falling brine and the rising carrier gas results in the output from the DCH 3100 of a second stream 3008 of the brine that has a lower temperature and a higher dissolved solids concentration (due to the loss of water vapor to the carrier gas) than the first stream 3013 of the brine entering the DCH 3100. The mass transferred between the brine and the carrier gas is a fraction of the brine's water content that evaporates into gaseous water vapor within the DCH 3100 and is attributed to the VLE between the two streams at any given point within the column of the DCH 3100; the extent of mass transfer is dependent upon variables that influence the VLE, such as brine concentration, liquid and vapor temperatures, and pressures, all of which may dynamically vary along the height of the column. At higher equilibrium temperatures between the vapor and liquid, the water content of the brine has a higher affinity to change phases and evaporate, and thus the temperature of the stream 3013 of the brine entering the DCH 3100 is greater, and preferably substantially greater, than the temperature of the stream 3001 of the carrier gas entering the DCH 3100 to increase the extent of mass transfer in the DCH 3100. As the brine descends through the column of the DCH 3100, heat is also continuously expelled from the liquid stream to overcome the latent heat of evaporation attributed to the phase change of the water vapor being exchanged to the carrier gas; this adiabatic cooling results in the temperature of the second stream 3008 of the brine exiting the DCH 3100 being significantly less than the temperature of the first stream 3013 of the brine entering the DCH 3100.

The condensate of the DCC undergoes a process that is effectively the intuitive opposite of the process that the brine of the DCH undergoes. Specifically, as a first stream 3019 of the condensate enters the DCC 3200 and falls under the force of gravity through the column of the DCC 3200, the transfer of mass and energy via direct contact between the falling condensate and the rising carrier gas results in the output from the DCC 3200 of a second stream 3015 of the condensate that has a higher temperature and a lower dissolved solids concentration (due to the gain of condensed liquid water from the carrier gas) than the first stream 3019 of the condensate entering the DCC 3200. Even more particularly, the humidified second stream 3002 of the carrier gas that exits the DCH 3100 and enters the DCC 3200 has a higher temperature than the first stream 3019 of the condensate, and as a result the condensate stream absorbs sensible heat, resulting in a decrease in the temperature of the ascending carrier gas across the height of the column of the DCC 3200. The sensible heat transfer between the condensate and the carrier gas is compounded by the latent heat of condensation as mass is transferred (i.e., water precipitates) from the carrier gas to the condensate. Stated slightly differently, the highly temperature-dependent VLE between the carrier gas and the condensate shifts across the height of the column of the DCC 3200 as the temperature of the carrier gas decreases, resulting in a lower equilibrium concentration of water in the vapor phase, inducing the condensation of water vapor, and compounding the heat transfer between the streams as the falling condensate stream absorbs the latent heat of condensing water vapor.

The mass transfer experienced by both the brine in the DCH 3100 and the condensate in the DCC 3200 requires a discharge of accrued mass prior to recirculation. Particularly, a portion of the salt content of the second stream 3008 of the brine exiting the DCH 3100 must be rejected, and water evaporated from the brine in the DCH 3100 must be replaced; this is achieved by discharging a fraction 3014 of the second stream 3008 of the brine (optionally, the second stream 3008 of the brine may be pumped via one or more pumps to increase its pressure and thus form a pressurized stream 3009 of brine), and then replacing the discharged water by combining the remainder 3010 of the brine with a relatively dilute (i.e., having a lower total dissolved solids content than the brine in the DCH 3100) stream 3021 of makeup brine. The volume ratio between the blowdown fraction 3014 and the makeup brine fraction 3021 is dictated by mass balance. As a result, the stream 3011 of brine resulting from the removal of the blowdown fraction 3014 and the addition of the makeup brine fraction 3021 has substantially the same total dissolved solids content as the stream 3013 of the brine entering the DCH 3100, and so can (after energy recovery operations described further below) be recirculated to the DCH 3100 as the influent brine stream 3013. The condensate, on the other hand, does not accrue salt through the dehumidification process in the DCC 3200, but the volumetric flowrate of the condensate stream 3015 exiting the DCC 3200 is greater than the volumetric flowrate of the condensate stream 3019 entering the DCC 3200; thus, a fraction 3020 of the second stream 3015 of the condensate is discharged as product water (optionally after pumping the second stream 3015 of condensate via one or more pumps to increase its pressure and thus form a pressurized stream 3016 of condensate).

At this point in the process, the brine streams 3013, 3008 entering and exiting the DCH 3100 have similar flowrates and solids concentrations, but dissimilar temperatures, i.e., the brine stream 3008 exiting the DCH 3100 has a lower temperature than the brine stream 3013 entering the DCH 3100 and must therefore absorb heat to meet the inlet set point temperature of the DCH 3100. Similarly but conversely, the condensate streams 3019, 3015 entering and exiting the DCC 3200 have similar flowrates and solids concentrations, but dissimilar temperatures, i.e., the condensate stream 3015 exiting the DCC 3200 has a higher temperature than the condensate stream 3019 entering the DCC 3200 and must therefore reject heat to meet the inlet set point temperature of the DCC 3200. Both of these objectives can be achieved by feeding brine stream 3011 (formed by removal of the blowdown fraction 3014 from, and addition of the makeup brine 3021 to, the brine exiting the DCH 3100) and condensate stream 3017 (formed by removal of the product water fraction 3020 from the condensate exiting the DCC 3200) to a recuperator (i.e., heat exchanger) 3300. Those of ordinary skill in the art will readily appreciate how to design or select an appropriate recuperator 3300 based on the desired inlet set point temperatures of the DCH 3100 and DCC 3200, as well as the temperature difference between brine stream 3011 and condensate stream 3017.

While the exchange of heat between brine stream 3011 and condensate stream 3017 in the recuperator 3300 greatly reduces the energy requirements of the overall water desalination system 3000, it is generally insufficient to heat the brine all the way to the inlet set point temperature of the brine stream 3013 influent to the DCH 3100 or to cool the condensate all the way to the inlet set point temperature of the condensate stream 3019 influent to the DCC 3200. Thus, the stream 3012 of brine exiting the recuperator 3300 is heated by a heat source 3400 to form the first stream 3013 of the brine, and the stream 3018 of condensate exiting the recuperator 3300 is cooled by a heat sink 3500 to form the first stream 3019 of the condensate. A wide variety of thermal sources may be utilized as the heat source 3400, such as, by way of non-limiting example, concentrated solar power sources, geothermal sources, industrial waste heat, petroleum-based thermal heaters, and the like. Similarly, a wide variety of cooling options may be utilized as the heat sink 3500, such as, by way of non-limiting example, cooling towers, air-cooled chillers, adiabatic coolers, dry air coolers, and the like. Specific implementations of heat source 3400 and/or heat sink 3500 that may further improve the energy efficiency of the overall water desalination system 3000 are described further below.

The partially closed loops of carrier gas, brine, and condensate in the water desalination system 3000 mitigate the amounts of moisture and useful heat that are lost to the environment. This feature increases the yield of product water and decreases the overall energy requirements of the water desalination system 3000. By way of first non-limiting example, in a water desalination system 3000 substantially as illustrated in FIG. 3, where an inlet temperature of the brine is 210° F. (98° C.) and the dissolved salt concentration in the brine is 20 wt % (200,000 ppm), for a typical composition of the makeup carrier gas (e.g., atmospheric air at 80° F. and 20% relative humidity), decreasing the carrier gas purge rate (i.e., the fraction of the third stream 3003 of carrier gas discharged as discharge fraction 3007) from 100% (no recirculation of carrier gas) to 10% (recirculating 90% of the carrier gas) ceteris paribus increases the water yield of the system (i.e., the proportion of water in the makeup brine stream 3021 recovered in the product water stream 3020) by 9.0% and decreases the total thermal load of the water desalination system 3000 by 9.4%; these gains are attributable to increased recovery of the liquid portion of the makeup brine 3021 in the product water stream 3020 and decreased loss of heat from the brine in the DCH 3100. By way of second non-limiting example, in which the conditions are the same as described in the previous sentence except that the inlet temperature of the brine is a relatively low 194° F. (90 ° C.), decreasing the carrier gas purge rate from 100% to 10% ceteris paribus increases the water yield by 28.3% and decreases the total thermal load of the water desalination system 3000 by 23.5%. These improvements can be attributed primarily to the moisture content of the second stream 3002 of carrier gas entering the DCC 3200; a higher moisture content can be achieved by mixing a larger fraction 3004 of the third stream 3003 of the carrier gas exiting the DCC 3200 with a relatively small quantity 3005 of less humid ambient air, and the greater the moisture content of the second stream 3002 of carrier gas entering the DCC 3200, the smaller the extent of evaporation that must take place within the DCH 3100 and thus the smaller the amount of water vapor that is exhausted to the environment. As these examples demonstrate, the relationship between the carrier gas purge rate and the water yield and/or system energy requirements is highly dependent upon the set point/inlet temperature of the brine (particularly, the lower the set point temperature, the greater the impact of the carrier gas purge rate); those of ordinary skill in the art can thus selectively vary the brine set point temperature and the carrier gas purge rate to achieve a desired improvement in water yield and/or energy consumption of the water desalination system 3000.

It is to be expressly understood that, in the foregoing discussion of the water desalination system 3000 illustrated in FIG. 3, any reference to a stream of a fluid entering either the DCH 3100 or the DCC 3200 may be split into multiple sub-streams, e.g., where the DCH 3100 or the DCC 3200 is an SCT as described in the preceding section of the disclosure, a separate sub-stream for each cassette of the SCT. By way of non-limiting example, where the DCH 3100 is an SCT, the first stream 3001 of the carrier gas may be separated into sub-streams 3001a, 3001b, 3001c, . . . and/or the first stream 3013 of the brine may be separated into sub-stream 3013a, 3013b, 3013c, . . . and each of these separate sub-streams may be provided to an individual cassette of the SCT DCH 3100.

One advantage of the water desalination system 3000 illustrated in FIG. 3 is that it is compatible with relatively high concentrations of total dissolved solids in the brine. Particularly, total dissolved solids concentrations in the brine are limited only by the saturation limits of the solution, which are dependent upon the specific solutes/salts present in the solution, and as a result, the concentration of total dissolved solids in the brine in the DCH 3100 can be optimized for a particular application and can be any concentration that is equal to or greater than the total dissolved solids concentration of the source of the makeup brine stream 3021 (e.g., seawater, brackish water, water produced from oil and/or gas extraction processes, flowback water, industrial or other types of wastewater, etc.). In some embodiments, a relatively large volumetric flowrate of the first brine stream 3013 (i.e., the brine stream influent to the DCH 3100) can result in relatively small differentials in total dissolved solids concentrations between this stream and the second brine stream 3008 (i.e., the brine stream flowing out of the DCH 3100); in some embodiments, the difference in total dissolved solids concentrations between these two streams may be no more than about 4.9%. This small differential in concentrations is beneficial in that it allows for the use of highly concentrated (theoretically, within about 5% of the saturation concentration) brine sources as the source of the makeup brine stream 3021. Furthermore, in many embodiments, the water desalination system 3000 may be part of a larger process that includes a downstream processing (e.g., crystallization) step in which salts or other solids of interest are precipitated from the blowdown brine fraction 3014 (or other effluent brine stream), and as the concentration of the first brine stream 3013 influent to the DCH 3100 approaches the saturation limit, the energy requirements of these downstream precipitation processes are reduced; by way of non-limiting example, where the brine solution is an aqueous solution of sodium chloride, increasing the sodium chloride concentration of the first/influent brine stream 3013 from 20 wt % to 25 wt % can reduce the thermal load of a downstream crystallizer system by 27%. A higher concentration of dissolved solids in the first/influent brine stream 3013 also increases its boiling point and thus the maximum allowable set point temperature at the liquid inlet of the DCH 3100 (which itself is advantageous as further described below); by way of non-limiting example, a 25 wt % aqueous sodium chloride solution has an approximate boiling point of 105.8° C., i.e., 5.8° C. higher than pure water, at atmospheric pressure.

Conversely but still advantageously, the water desalination system 3000 illustrated in FIG. 3 is also compatible with relatively low source water total dissolved solids concentrations; in some embodiments, the total dissolved solids concentration of the first/influent brine stream 3013 may be as low as about 500 ppm (0.05 wt %). The flexibility to operate with low-concentration brines can affect the VLE within the DCH 3100 and thus increase the brine's affinity for evaporation, resulting in a higher ratio of water vapor to carrier gas and thus reducing the required carrier gas flowrate; by way of non-limiting example, where the brine solution is an aqueous solution of sodium chloride and the carrier gas is air, reducing the sodium chloride concentration of the first/influent brine stream 3013 from 25 wt % to 5 wt % can, ceteris paribus, reduce the flowrate of the carrier gas required to yield a given volume of fresh water by 72%, thereby dramatically reducing required column sizes, electrical/energy requirements, and so on.

Another advantage of the water desalination system 3000 illustrated in FIG. 3 is that it can operate at a high brine set point temperature, i.e., the first/influent brine stream 3013 can have a high temperature, in many embodiments close to the boiling point of the first/influent brine stream 3013. The flexibility to operate with high-temperature brines can affect the VLE within the DCH 3100 and thus increase the brine's affinity for evaporation, resulting in a higher ratio of water vapor to carrier gas and thus reducing the required carrier gas flowrate; by way of non-limiting example, where the first/influent brine solution is a 25 wt % solution of sodium chloride in water and the carrier gas is air, increasing the set point temperature of the first/influent brine stream 3013 from 90° C. to 105° C. (0.8° C. below the solution's boiling point) can, ceteris paribus, reduce the flowrate of the carrier gas required to yield a given volume of fresh water by 92%, thereby dramatically reducing required column sizes, electrical/energy requirements, and so on. In many embodiments, practically the only constraints on the brine set point temperature of the DCH 3100 are the boiling point of the first/influent brine stream 3013 and limitations (e.g., corrosion rates, etc.) related to the materials of construction of the DCH 3100.

Still another advantage of the water desalination system 3000 illustrated in FIG. 3 is that altering the set point temperatures of the liquid streams influent to the DCH 3100 and the DCC 3200 (i.e., the temperatures of the first brine stream 3013 and the first condensate stream 3019) causes the temperatures of the liquid streams discharged from the DCH 3100 and DCC 3200 (i.e., the temperatures of the second brine stream 3008 and the second condensate stream 3015) to vary in predictable manners; in general, the larger the differential in temperature between the respective inlet streams, the larger the differential in temperature between the respective outlet streams. The setpoints can thus be strategically manipulated to yield a desired differential between the temperature of the second brine stream 3008 output from the DCH 3100 and the second condensate stream 3015 output from the DCC 3200. Larger temperature differentials between the second brine stream 3008 and the second condensate stream 3015 imply that each stream can cool or heat the other stream to a greater extent within the recuperator 3300; this is generally beneficial because in most embodiments it is preferable that at least about 75% of the required heating of the brine stream and/or of the required cooling of the condensate stream be achieved by the recuperator 3300, so as to minimize the energy requirements of the heat source 3400 and the heat sink 3500. By way of non-limiting example, where the brine solution is an aqueous solution of sodium chloride, the condensate is water, the temperature of the first/influent brine stream 3013 is 105° C., and the temperature of the first/influent condensate stream 3019 is 38° C., and the recuperator is designed to achieve a temperature differential of 2° F. between the brine stream and the condensate stream, 88% of the heating required to bring the second/outlet brine stream 3008 back up to the setpoint temperature can be achieved by the recuperator 3300, such that only 12% of this heating must be achieved by the heat source 3400. The use of the recuperator 3300 can thus reduce the total thermal energy inputs to the water desalination system 3000 by at least about 75%, and in some embodiments by at least about 86%.

### Heat Sources and Heat Sinks

As the generalized illustrations of the heat source 3400 and the heat sink 3500 in FIG. 3 imply, many different variations and implementations of these components are possible. For a given application, the best options for the heat source 3400 and the heat sink 3500 consider the total energy input requirements of the overall water desalination system 3000, which include, but are not necessarily limited to, the thermal and electrical loads of the process and of all process equipment (pumps, blowers, controls, etc.). Thus, in most embodiments, it is desirable to maximize energy recovery, and minimize loss of useful energy, from system components other than the heat source 3400 and the heat sink 3500, so as to minimize the amount of energy that must be input to the system by the heat source 3400 and/or the amount of energy that must be removed from the system by the heat sink 3500.

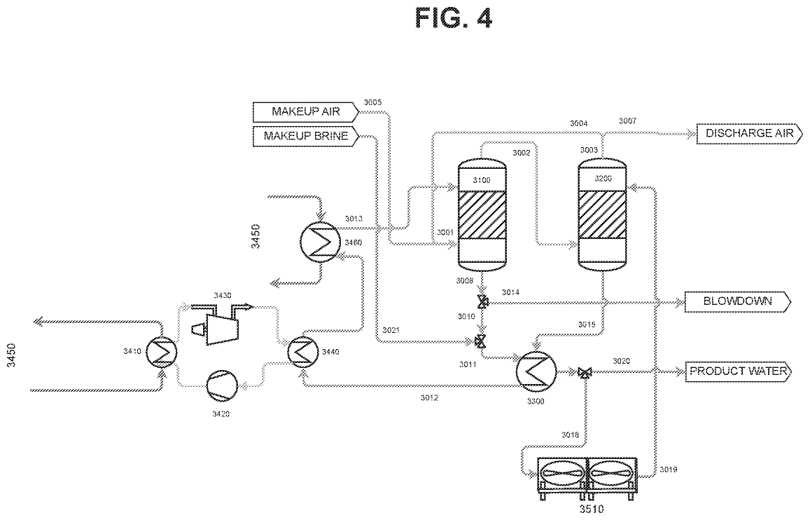

Referring now to FIG. 4, the heat source 3400 is a heat engine that derives energy from a mid-grade thermal resource 3450, i.e., a heat source that can provide process heat having a temperature from about 100 ° C. to about 400° C.; mid-grade heat can be obtained from a wide-variety of different sources, such as, by way of non-limiting example, concentrated solar power sources, geothermal sources, industrial waste heat, petroleum-based thermal heaters, and the like. The heat engine 3400 is configured to convert the thermal energy supplied by the thermal resource 3450 into both mechanical work and electricity, the latter of which can be used to meet the electrical load of all relevant process equipment.

The heat engine 3400 depicted in FIG. 4 is an ideal Rankine cycle. The thermal efficiency (i.e., the percentage of thermal energy input that is output as electrical power) of such a cycle that exploits a mid-grade heat source may be low as 10%, implying that up to 90% of the thermal energy supplied to the heat engine 3400 by the thermal resource 3450 may be rejected by the cycle (if the cycle pumping load is disregarded); the water desalination system 3000 can recover this rejected heat to heat influent brine stream 3012 such that the temperature of the output brine stream 3013 is equal to the input set point temperature of the DCH 3100.

As illustrated in FIG. 4, heat is supplied to the working fluid of the Rankine cycle (most commonly steam) via an evaporator 3410. An expander 3420, coupled with an electric generator 3430, extracts mechanical work from the steam to produce electricity, and the excess heat of the expanded steam is exhausted within a condenser 3440; the heat exhausted in the condenser 3440 can then be recovered in brine stream 3012. The resulting effective thermal efficiency of the heat engine 3400 can thus approach 100% (although in practice there will be small losses due to thermodynamic and mechanical efficiencies), and as a result the recovery of heat from the heat engine 3400 by brine stream 3012 to form the first brine stream 3013 can serve as the primary heat source of the overall water desalination system 3000, although if necessary, additional heat can be provided by a secondary downstream heat exchanger 3460 that directly couples the mid-grade thermal resource 3450 to a process stream. The present inventors conservatively estimate that for every 1,000 watts of thermal energy supplied to the heat engine 3400, 100 watts of electricity are generated and 881 watts of heat are dissipated by the condenser 3440, and that under typical operating conditions, using this heat to reheat the brine stream can reduce the total thermal energy input demand of the water desalination system 3000 by about 34.5% (relative to a scenario in which the Rankine cycle's waste heat is exhausted to the environment). As a result, the embodiment of the water desalination system 3000 illustrated in FIG. 4 may be suitable for deployment in environments where mid-grade heat is the only, or best, viable or available source of energy, e.g., in remote, rugged, or underdeveloped areas.

Also illustrated in FIG. 4 is the use of an organic Rankine cycle (ORC)-integrated dry air cooler (DAC) 3510 as the heat sink 3500. In a manner similar to that of the heat engine used as the heat source 3400 described above, the ORC-integrated DAC 3510 utilizes the heat within a fluid to produce electricity; however, the ORC-integrated DAC 3510 has a net-zero electrical output, and the electrical energy produced by the engine is regulated to meet the electrical load of the encompassing assembly, which utilizes large fans to extract heat from the process stream via convection of cooler ambient air. Thus, although the waste heat is expelled from the water desalination system 3000, the exploitation of the low-grade process heat present in condensate stream 3018 can achieve the required cooling load while requiring no auxiliary power input. The use of an ORC-integrated DAC 3510 as the heat sink 3500 can thus provide substantial energy savings by comparison to conventional DAC technologies, which typically consume significant energy that must be externally supplied; the present inventors conservatively estimate that in a typical embodiment in which a cooling load of the heat sink 3500 is about 1.8 megawatts, a conventional dry-air cooler sized to meet this load would require 638 kilowatts of electrical power. Moreover, unlike cooling towers and adiabatic coolers, the ORC-integrated DAC 3510 consumes no water; consumption of water by the heat sink 3500 is self-evidently counterproductive where the purpose of the system 3000 is to produce fresh water.

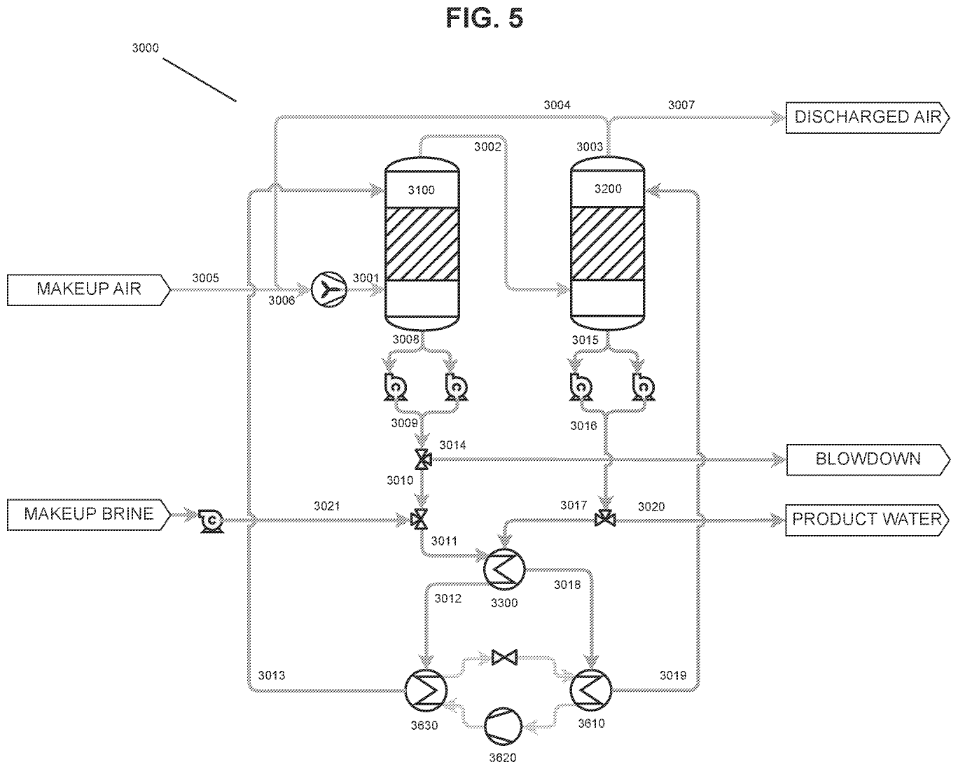

Referring now to FIG. 5, another embodiment of a water desalination system 3000 as illustrated in FIG. 3 integrates a heat pump 3600 to serve as both the heat source 3400 and the heat sink 3500. As those skilled in the art readily understand and appreciate, a heat pump uses mechanical work to transfer heat from a lower-temperature heat source to a higher-temperature heat sink. In the embodiment illustrated in FIG. 5, the heat pump 3600 removes heat from the condensate stream 3018 via a first heat exchanger 3610 and supplies that heat to the brine stream 3012 via a second heat exchanger 3630, at the cost of the electrical load of a compressor 3620.

The energy efficiency of heat pumps is typically represented by the ratio of heat exchanged by the heat pump to the electricity required to operate the heat pump; this ratio is known as the coefficient of performance (COP). In embodiments of the present disclosure, the COP of the heat pump 3600 may be at least as high as about 6.0, i.e., for each watt of electricity consumed by the compressor 3620, six watts of thermal energy are transferred from the condensate stream 3018 to the brine stream 3012. This COP is much higher than conventional electrically-derived heating technologies, such as electrical resistance heating, which has a theoretical maximum COP of 1.0. In practice, the heat pump 3600 may exhibit a slight imbalance between cooling utility and heating utility, as more heat is rejected by the equipment due to thermal and mechanical inefficiencies; those skilled in the art will understand how to optimize and regulate the operating conditions of the water desalination system 3000 to ensure that the heat pump 3600 can meet both the heating and cooling loads of the system without the need for additional auxiliary equipment. This implies that the water desalination system 3000 illustrated in FIG. 5 can operate in the absence of any external thermal source, i.e., where the only energy input from external sources is electrical energy; this feature greatly expands the range of locations where the system 3000 can be deployed, e.g., to areas where few or no sources of thermal energy are available, or where electrical power generation sources (e.g., solar, wind, etc.) are renewable and/or sustainable and it is thus desirable to power systems using solely these sources to the greatest extent possible.

### Additional Considerations

While the foregoing discussion has generally focused on water as the main process liquid of interest and sodium chloride as the main solute of interest, it is to be expressly understood that a direct-contact evaporator as disclosed herein may concentrate any condensable fluid of interest in liquid phase containing any dissolved salt of interest, and a direct-contact condenser as disclosed herein may condense any condensable fluid of interest. Non-limiting illustrative examples of suitable condensable fluids include water, ammonia, benzene, toluene, ethyl benzene, alcohols, and combinations and mixtures thereof. In addition to the condensable fluid in liquid phase, a brine stream flowing into or out of a direct-contact evaporator as disclosed and/or a condensate stream flowing into or out of a direct-contact condenser as disclosed herein may further comprise one or more additional liquids (i.e., the liquid stream may be a stream of a mixture of liquids). Non-limiting examples of dissolved salts whose concentrations in a brine stream may be increased in a direct-contact evaporator as disclosed herein and/or whose concentrations in a condensate stream may be decreased in a direct-contact condenser as disclosed herein include sodium chloride (NaCl), sodium bromide (NaBr), potassium chloride (KCl), potassium bromide (KBr), ammonium chloride (NH₄Cl), calcium chloride (CaCl₂), magnesium chloride (MgCl₂), sodium carbonate (Na₂CO₃), sodium bicarbonate (NaHCO₃), potassium bicarbonate (KHCO₃), sodium sulfate (Na₂SO₄), potassium sulfate (K₂SO₄), calcium sulfate (CaSO₄), magnesium sulfate (MgSO₄), strontium sulfate (SrSO₄), barium sulfate (BaSO₄), barium-strontium sulfate (BaSr(SO₄)₂), calcium nitrate (Ca(NO₃)₂), iron (III) hydroxide (Fe(OH)₃), iron (III) carbonate (Fe₂(CO₃)₃), aluminum hydroxide (Al(OH)₃), aluminum carbonate (Al₂(CO₃)₃), ammonium carbonate, ammonium bicarbonate, ammonium sulfate, boron salts, polyacrylic acid sodium salts, silicates, and combinations and mixtures thereof.

In some embodiments, the brine stream comprises saltwater, i.e., a solution of one or more salts dissolved in water. The saltwater may comprise seawater, brackish water, water produced from an oil and/or gas extraction process, flowback water, and/or wastewater (e.g., industrial wastewater). Non-limiting examples of wastewater include textile mill wastewater, leather tannery wastewater, paper mill wastewater, cooling tower blowdown water, flue gas desulfurization wastewater, landfill leachate water, the effluent of a chemical process (e.g., the effluent of another desalination system and/or chemical process), and combinations and mixtures thereof.

In some embodiments, the temperature of a brine solution entering a direct-contact evaporator as disclosed herein may be advantageously close to the boiling point of the brine solution, so long as it does not exceed the boiling point of the brine solution (i.e., so long as the brine solution does not boil). More specifically, a difference between the boiling point of the brine solution and the temperature of the brine solution (i.e., the boiling point minus the temperature) is greater than zero but may be, by way of non-limiting example, no more than about 15° C., no more than about 14° C., no more than about 13° C., no more than about 12° C., no more than about 11° C., no more than about 10° C., no more than about 9° C., no more than about 8° C., no more than about 7° C., no more than about 6° C., no more than about 5° C., no more than about 4° C., no more than about 3° C., no more than about 2° C., no more than about 1° C., no more than about 0.9° C., no more than about 0.8° C., no more than about 0.7° C., no more than about 0.6° C., no more than about 0.5° C., no more than about 0.4° C., no more than about 0.3° C., no more than about 0.2° C., or no more than about 0.1° C. Previous attempts at improving the energy efficiency of thermally driven evaporation/condensation systems, particularly HDH desalination systems, have often attempted to achieve greater efficiencies by reducing the brine set point temperature to reduce heating requirements, but this design choice necessarily entails the tradeoff of altering the VLE within the humidifier/evaporator in a way that can decrease the effectiveness of heat and mass transfer within the column. The systems of the present disclosure can thus improve upon earlier attempts by achieving at least comparable, and in many embodiments improved, energy efficiencies while also keeping the brine set point temperature higher to better exploit VLE changes within the humidifier/evaporator.

In some embodiments, a brine solution entering or exiting a direct-contact evaporator as disclosed herein may have a relatively high, or relatively low, concentration of the dissolved salt. In certain embodiments, the concentration of the dissolved salt in the brine solution may be at least about 1,000 mg/L, at least about 5,000 mg/L, at least about 10,000 mg/L, at least about 50,000 mg/L, at least about 100,000 mg/L, at least about 150,000 mg/L, at least about 200,000 mg/L, at least about 250,000 mg/L, at least about 300,000 mg/L, at least about 350,000 mg/L, or at least about 375,000 mg/L (and/or, in certain embodiments, up to the saturation limit of the dissolved salt in the brine solution), and/or, additionally or alternatively, no more than about 375,000 mg/L, no more than about 350,000 mg/L, no more than about 300,000 mg/L, no more than about 250,000 mg/L, no more than about 200,000 mg/L, no more than about 150,000 mg/L, no more than about 100,000 mg/L, no more than about 50,000 mg/L, no more than about 10,000 mg/L, or no more than about 1,000 mg/L. In some embodiments, the concentration of the dissolved salt in the brine solution may be in any range having a lower bound of any whole number of milligrams per liter from 1 mg/L to the lower of 375,000 mg/L and the saturation limit and an upper bound of any other whole number of milligrams per liter from 1 mg/L to the lower of 375,000 mg/L and the saturation limit. The concentration of a dissolved salt generally refers to the combined concentrations of the cation(s) and the anion(s) of the salt; for example, the concentration of dissolved sodium chloride (NaCl) in solution is the sum of the concentration of sodium ions (Na⁺) and the concentration of chloride ions (Cl⁻).

In some embodiments, a brine solution entering or exiting a direct-contact evaporator as disclosed herein contains a dissolved salt in an amount of at least about 1 wt %, at least about 5 wt %, at least about 10 wt %, at least about 15 wt %, at least about 20 wt %, at least about 25 wt %, at least about 26 wt %, at least about 27 wt %, at least about 28 wt %, at least about 29 wt %, or at least about 30 wt % (and/or, in certain embodiments, up to the saturation limit of the dissolved salt in the brine solution), and/or, additionally or alternatively, no more than about 30 wt %, no more than about 29 wt %, no more than about 28 wt %, no more than about 27 wt %, no more than about 26 wt %, no more than about 25 wt %, no more than about 20 wt %, no more than about 15 wt %, no more than about 10 wt %, no more than about 5 wt %, or no more than about 1 wt %. In some embodiments, the amount of the dissolved salt in the brine solution may be in any range having a lower bound of any whole number of parts per million from 500 ppm to the lower of 300,000 ppm and the saturation limit and an upper bound of any other whole number of parts per million from 500 ppm to the lower of 300,000 ppm and the saturation limit.

In some embodiments, a condensate stream exiting a direct-contact condenser as disclosed herein may be a substantially pure stream of the condensable liquid. Particularly, the condensable liquid may make up at least about 95 wt %, at least about 99 wt %, at least about 99.9 wt %, at least about 99.99 wt %, or at least about 99.998 wt % of the condensate stream. Additionally or alternatively, a concentration of the dissolved salt, or in some cases of total dissolved solids, in the condensate stream may be no more than about 500 mg/L, no more than about 200 mg/L, no more than about 100 mg/L, no more than about 50 mg/L, no more than about 20 mg/L, no more than about 10 mg/L, no more than about 5 mg/L, no more than about 2 mg/L, no more than about 1 mg/L, no more than about 0.5 mg/L, no more than about 0.2 mg/L, no more than about 0.1 mg/L, no more than about 0.05 mg/L, no more than about 0.02 mg/L, or no more than about 0.01 mg/L. In some embodiments, the concentration of the dissolved salt and/or total dissolved solids in the condensate stream may be undetectable, or may be in any range having a lower bound of any whole number of micrograms per liter from 1 μg/L to 500 mg/L and an upper bound of any other whole number of micrograms per liter from 1 μg/L to 500 mg/L.

In some embodiments, the condensate stream may contain the dissolved salt in an amount, or contains an amount of total dissolved solids, of no more than about 2 wt % (20,000 ppm), no more than about 1 wt % (10,000 ppm), no more than about 0.5 wt % (5,000 ppm), no more than about 0.2 wt % (2,000 ppm), no more than about 0.1 wt % (1,000 ppm), no more than about 0.05 wt % (500 ppm), no more than about 0.02 wt % (200 ppm), no more than about 0.01 wt % (100 ppm), no more than about 0.005 wt % (50 ppm), or no more than about 0.002 wt % (20 ppm). In some embodiments, the amount of the dissolved salt and/or of total dissolved solids in the condensate stream may be in any range having a lower bound of any whole number of parts per million from 1 ppm to 20,000 ppm and an upper bound of any other whole number of parts per million from 1 ppm to 20,000 ppm.

Unless otherwise specified, any heat exchanger disclosed herein may have any suitable architecture, such as, by way of non-limiting example, a plate-and-frame heat exchanger, a shell-and-tube heat exchanger, a tube-and-tube heat exchanger, a plate heat exchanger, a plate-and-shell heat exchanger, and so on. In some embodiments, any one or more heat exchangers of any system or method disclosed herein may exhibit a relatively high heat transfer rate, e.g., the heat exchanger may have a heat transfer coefficient at least about 150 W/(m² K), at least about 200 W/(m² K), at least about 500 W/(m² K), at least about 1000 W/(m² K), at least about 2000 W/(m² K), at least about 3000 W/(m² K), at least about 4000 W/(m² K), at least about 5000 W/(m² K), at least about 6000 W/(m² K), at least about 7000 W/(m² K), at least about 8000 W/(m² K), at least about 9000 W/(m² K), or at least about 10,000 W/(m² K). In some embodiments, a heat exchanger may have a heat transfer coefficient in any range having a lower bound of any whole number of watts per square meter per kelvin from 150 W/(m² K) to 10,000 W/(m² K) and an upper bound of any other whole number of watts per square meter per kelvin from 150 W/(m² K) to 10,000 W/(m² K).

A recuperator, heat source, or heat sink as disclosed herein may heat or cool a liquid stream flowing through (or otherwise in contact with) the recuperator, heat source, or heat sink by at least about 5° C., at least about 10° C., at least about 15° C., at least about 20° C., at least about 25° C., at least about 30° C., at least about 35° C., at least about 40° C., at least about 45° C., or at least about 50° C. Additionally or alternatively, a temperature rise of a liquid stream in a recuperator or heat source as disclosed herein and/or a temperature drop of a liquid stream in a recuperator or heat sink as disclosed herein may be in any range having a lower bound of any whole number of degrees Celsius from 1° C. to 50° C. and an upper bound of any other whole number of degrees Celsius from 1° C. to 50° C.

In some embodiments, a carrier gas as disclosed herein may comprise, in addition to a condensable vapor (e.g., water vapor), one or more non-condensable gases. Non-limiting examples of suitable non-condensable gases include air, nitrogen gas (N₂), oxygen gas (O₂), helium (He), argon (Ar), carbon monoxide (CO), carbon dioxide (CO₂), sulfur oxides (SOₓ, e.g., sulfur dioxide (SO₂), sulfur trioxide (SO₃), etc.), nitrogen oxides (NOₓ, e.g., nitric oxide (NO), nitrogen dioxide (NO₂), etc.), and combinations and mixtures thereof. In some embodiments, the carrier gas may be a gas mixture (i.e., may comprise at least one non-condensable gas and one or more additional gases).

In some embodiments, a pressure drop of the carrier gas in a direct-contact evaporator or direct-contact condenser as disclosed herein (i.e., a difference between the pressure of the carrier gas stream entering the direct-contact evaporator or direct-contact condenser and the pressure of the carrier gas stream exiting the direct-contact evaporator or direct-contact condenser) may be no more than about 100 kPa, no more than about 75 kPa, no more than about 50 kPa, no more than about 20 kPa, no more than about 10 kPa, no more than about 5 kPa, no more than about 2 kPa, or no more than about 1 kPa. In some embodiments, the pressure drop of the carrier gas in a direct-contact evaporator or direct-contact condenser as disclosed herein may be in any range having a lower bound of any whole number of pascals from 1 Pa to 100 kPa and an upper bound of any other whole number of pascals from 1 Pa to 100 kPa.

The concepts illustratively disclosed herein suitably may be practiced in the absence of any element which is not specifically disclosed herein. It is apparent to those skilled in the art, however, that many changes, variations, modifications, other uses, and applications of the disclosure are possible, and changes, variations, modifications, other uses, and applications which do not depart from the spirit and scope of the disclosure are deemed to be covered by the disclosure.

The foregoing discussion has been presented for purposes of illustration and description. The foregoing is not intended to limit the disclosure to the form or forms disclosed herein. In the foregoing Detailed Description, for example, various features are grouped together in one or more embodiments for the purpose of streamlining the disclosure. The features of the embodiments may be combined in alternate embodiments other than those discussed above. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment.

Moreover, though the present disclosure has included description of one or more embodiments and certain variations and modifications, other variations, combinations, and modifications are within the scope of the disclosure, e.g., as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

What is claimed is:

1. A water desalination system, comprising:
a direct-contact humidifier, configured to receive a first stream of a carrier gas and a first stream of a brine and place the first stream of the carrier gas and the first stream of the brine in direct contact to cause transfer of heat and water from the first stream of the brine to the first stream of the carrier gas to form a second stream of the carrier gas and a second stream of the brine, wherein the first stream of the brine has a brine set point temperature;
a direct-contact condenser, configured to receive the second stream of the carrier gas and a first stream of a condensate and place the second stream of the carrier gas and the first stream of the condensate in direct contact to cause transfer of heat and water from the second stream of the carrier gas to the first stream of the condensate to form a third stream of the carrier gas and a second stream of the condensate, wherein the first stream of the condensate has a condensate set point temperature;
a blowdown conduit, configured to discharge a portion of the second stream of the brine from the water desalination system to form a third stream of the brine;
a makeup brine conduit, configured to combine the third stream of the brine with a stream of makeup brine to form a fourth stream of the brine;
a gas discharge conduit, configured to discharge a portion of the second stream of the carrier gas to form a third stream of the carrier gas;
a makeup carrier gas conduit, configured to combine the third stream of the carrier gas with a makeup carrier gas stream to form the first stream of the carrier gas for recycle to the direct-contact humidifier;
a product water conduit, configured to discharge a portion of the second stream of the condensate from the water desalination system as a product water stream and thereby form a third stream of the condensate;
a recuperator, configured to receive the fourth stream of the brine and the third stream of the condensate and exchange heat from the third stream of the condensate to the fourth stream of the brine to form a fifth stream of the brine and a fourth stream of the condensate;
a heat source, configured to heat the fifth stream of the brine to the brine set point temperature and thereby form the first stream of the brine for recycle to the direct-contact humidifier; and
a heat sink, configured to cool the fourth stream of the condensate to the condensate set point temperature and thereby form the first stream of the condensate for recycle to the direct-contact condenser.

2. The water desalination system of claim 1, wherein the heat source is a heat engine comprising:
an evaporator, configured to receive heat from a thermal source and supply at least a portion of the received heat to a working fluid of the heat engine;
an expander and an electric generator, collectively configured to extract mechanical work from the working fluid to produce electricity; and
a condenser, configured to receive the working fluid and the fifth stream of the brine and exchange heat from the working fluid to the fifth stream of the brine.

3. The water desalination system of claim 1-or wherein the heat sink comprises an organic Rankine cycle-integrated dry air cooler.

4. The water desalination system of claim 1, wherein the heat source and the heat sink are collectively configured as a heat pump comprising:
a first heat exchanger, configured to receive the fourth stream of the condensate and a first stream of a refrigerant and exchange heat from the fourth stream of the condensate to the first stream of the refrigerant to form a second stream of the refrigerant;
a compressor, configured to compress the second stream of the refrigerant to form a third stream of the refrigerant; and
a second heat exchanger, configured to receive the fifth stream of the brine and the third stream of the refrigerant and exchange heat from the third stream of the refrigerant to the fifth stream of the brine to form the first stream of the refrigerant for recycle to the first heat exchanger.

5. The water desalination system of claim 1, wherein at least one of the direct-contact humidifier and the direct-contact condenser comprises a stacked cassette tower.

6. The water desalination system of claim 1, wherein a total dissolved solids content of the product water stream is no more than about 20 ppm.

7. The water desalination system of claim 1, wherein the carrier gas comprises air.

8. The water desalination system of claim 1, further comprising a blower configured to induce a pressure gradient of the carrier gas in the direct-contact humidifier.

9. The water desalination system of claim 1, wherein the portion of the second stream of the carrier gas discharged by the gas discharge conduit is about 5.0% to about 15.0%, by mass or volume, of the second stream of the carrier gas.

10-25. (canceled)

26. A method for producing fresh water, comprising:
(a) contacting a first stream of a carrier gas and a first stream of a brine to cause transfer of heat and water from the first stream of the brine to the first stream of the carrier gas to form a second stream of the carrier gas and a second stream of the brine, wherein the first stream of the brine has a brine set point temperature;
(b) contacting the second stream of the carrier gas and a first stream of a condensate to cause transfer of heat and water from the second stream of the carrier gas to the first stream of the condensate to form a third stream of the carrier gas and a second stream of the condensate, wherein the first stream of the condensate has a condensate set point temperature;
(c) discharging a portion of the second stream of the brine to form a third stream of the brine;
(d) combining the third stream of the brine with a stream of makeup brine to form a fourth stream of the brine;
(e) discharging a portion of the second stream of the carrier gas to form a third stream of the carrier gas;
(f) combining the third stream of the carrier gas with a makeup carrier gas stream to form the first stream of the carrier gas for recycle to step (a);
(g) discharging a portion of the second stream of the condensate as a product water stream to thereby form a third stream of the condensate;
(h) exchanging heat from the third stream of the condensate to the fourth stream of the brine to form a fifth stream of the brine and a fourth stream of the condensate;
(i) heating the fifth stream of the brine to the brine set point temperature to thereby form the first stream of the brine for recycle to step (a); and
(j) cooling the fourth stream of the condensate to the condensate set point temperature to thereby form the first stream of the condensate for recycle to step (b).

27. The method of claim 26, wherein step (i) comprises:
receiving heat from a thermal source and supplying at least a portion of the received heat to a working fluid of a heat engine;
extracting mechanical work from the working fluid to produce electricity; and
exchanging heat from the working fluid to the fifth stream of the brine.

28. The method of claim 26, wherein:
step (j) comprises exchanging heat from the fourth stream of the condensate to a first stream of a refrigerant to form a second stream of the refrigerant;
the method further comprises compressing the second stream of the refrigerant to form a third stream of the refrigerant; and
step (i) comprises exchanging heat from the third stream of the refrigerant to the fifth stream of the brine to form the first stream of the refrigerant for recycle to step (j).

29. The method of claim 26, wherein a total dissolved solids content of the product water stream is no more than about ppm.

30. The method of claim 26, wherein the carrier gas comprises air.

31. The method of claim 26, wherein the portion of the second stream of the carrier gas discharged in step (e) is about 5.0% to about 15.0%, by mass or volume, of the second stream of the carrier gas.

32-44. (canceled)

45. A stacked cassette tower (SCT) useful as a direct-contact condenser and/or a direct-contact evaporator, comprising:
N interconnected cassettes arranged in a vertical stack, where Nis an integer greater than or equal to two, each cassette having a circular or nearly circular cross-section and comprising:
a lower chamber, comprising a substantially fluid-impermeable floor;
an upper chamber;
a vertical wall, disposed about a circumference of the cassette and defining an outermost extent of the cassette, comprising a plurality of orifices in a portion of the vertical wall associated with the upper chamber;
a barrier layer, lying between the lower chamber and the upper chamber and comprising a perforation array, the perforation array comprising a plurality of perforations extending through an entirety of a thickness of the barrier layer and permitting flow of a carrier gas from the lower chamber into the upper chamber; and
a downpipe, in fluid communication with the upper chamber and extending downwardly from the upper chamber through an entirety of a height of the lower chamber;
an outer cylinder, having a circular or nearly circular cross-section and comprising:
a base;
at least one carrier gas inlet, in fluid communication with both a source of the carrier gas and the lower chamber of at least one cassette and configured to convey the carrier gas from the source of the carrier gas into the lower chamber of the at least one cassette; and
at least one liquid inlet, in fluid communication with both a source of a liquid and the upper chamber of at least one cassette and configured to convey the liquid from the source of the liquid into the upper chamber of the at least one cassette; and
a lid, comprising a carrier gas outlet,
wherein an outer diameter of each of the cassettes is less than an inner diameter of the outer cylinder such that an annular space exists within the outer cylinder between the stack of cassettes and the outer cylinder,
wherein the plurality of orifices in the vertical wall of each cassette is in fluid communication with the annular space and permits flow of the carrier gas from the upper chamber of each cassette into the annular space,
wherein a lower end of the downpipe of each cassette other than the bottom-most cassette in the stack penetrates through the floor of the lower chamber and thereafter terminates in, and is in fluid communication with, an upper end of the downpipe of the immediately below cassette, and
wherein a lower end of the downpipe of the bottom-most cassette in the stack is in fluid communication with, and configured to dispense a stream of the liquid into, a reservoir contained within the base of the outer cylinder.

46. The SCT of claim 45, wherein the SCT comprises from two to ten cassettes.

47-49. (canceled)

50. The SCT of claim 45, wherein the perforation array of at least one cassette comprises about 2,000 to about 200,000 perforations.

51. (canceled)

52. The SCT of claim 45, wherein at least one of the following is true:
(i) the at least one carrier gas inlet comprises N carrier gas inlets, wherein each of the N carrier gas inlets is in fluid communication with the dry chamber of a separate cassette; and
(ii) the at least one liquid inlet comprises N liquid inlets, wherein each of the N liquid inlets is in fluid communication with the wet chamber of a separate cassette.

53-56. (canceled)

57. The SCT of claim 45, wherein at least one cassette is mechanically interlocked and/or interconnected to the lid.

58. (canceled)
